(19) United States
(12) Patent Application Publication
(10) Pub. No.: US 2024/0311707 A1
(43) Pub. Date: Sep. 19, 2024

(54) MOBILE ROBOT ALLOCATION SYSTEM AND MOBILE ROBOT ALLOCATION METHOD

(71) Applicant: Panasonic Intellectual Property Management Co., Ltd., Kadoma-shi, Osaka (JP)

(72) Inventors: Tsunenori SANO, Fukuoka (JP); Hirokazu TAKEHARA, Fukuoka (JP)

(21) Appl. No.: 18/575,005

(22) PCT Filed: May 9, 2022
(86) PCT No.: PCT/JP2022/019711

§ 371 Date: Dec. 28, 2023

(30) Foreign Application Priority Data
Aug. 23, 2021 (JP) 2021-135386

(51) Int. Cl. G06Q 10/0631; G05D 1/698; G05D 107/70

(52) U.S. Cl. CPC G06Q 10/0631; G05D 1/6987; G05D 2107/70

(57) ABSTRACT

A mobile robot allocation system includes an obtainer, an allocator, and an outputter. The obtainer obtains task status information regarding a task status of each of a plurality of areas, the plurality of areas each including a plurality of machines. The allocator allocates, based on the task status information obtained by the obtainer, a plurality of mobile robots to the plurality of areas, the plurality of mobile robots each moving and performing a task in an area among the plurality of areas. The outputter outputs allocation information indicating allocation of the plurality of mobile robots performed by the allocator.

### TECHNICAL FIELD

The present disclosure relates to a mobile robot allocation system and a mobile robot allocation method for allocating a plurality of mobile robots to a plurality of areas.

### BACKGROUND ART

Patent Literature (PTL) 1 discloses a component mounting system equipped with a self-propelled component replenishing apparatus (mobile robot) that moves automatically while holding a storage container containing a plurality of components and replenishes the components in the storage container for a component supply device.

### CITATION LIST

### Patent Literature

### [PTL 1]

Japanese Unexamined Patent Application Publication No. 2017-216379

### SUMMARY OF INVENTION

### Technical Problem

The present disclosure provides, for example, a mobile robot allocation system that enables allocation of a plurality of mobile robots to a plurality of areas to be easily optimized.

### Solution to Problem

A mobile robot allocation system according to one aspect of the present disclosure includes an obtainer, an allocator, and an outputter. The obtainer obtains task status information regarding a task status of each of a plurality of areas, the plurality of areas each including a plurality of machines. The allocator allocates, based on the task status information obtained by the obtainer, a plurality of mobile robots to the plurality of areas, the plurality of mobile robots each moving and performing a task in an area among the plurality of areas. The outputter outputs allocation information indicating allocation of the plurality of mobile robots performed by the allocator.

These general or specific aspects may be implemented using a system, an apparatus, a method, a recording medium, or a computer program, or any combination of systems, apparatuses, methods, recording media, and computer programs.

### Advantageous Effects of Invention

With the mobile robot allocation system, etc. according to the present disclosure, the allocation of the plurality of mobile robots to the plurality of areas can be easily optimized.

### BRIEF DESCRIPTION OF DRAWINGS

FIG. 1 is a schematic diagram illustrating an application example of a mobile robot allocation system according to an embodiment.

FIG. 2 is a configuration diagram illustrating an example of an overall configuration including the mobile robot allocation system according to the embodiment.

FIG. 3 is a flowchart showing exemplary operations of the mobile robot allocation system according to the embodiment.

FIG. 4 is a schematic diagram illustrating an example of use of the mobile robot allocation system according to the embodiment.

FIG. 5 is a schematic diagram illustrating an example of use of the mobile robot allocation system according to the embodiment.

### DESCRIPTION OF EMBODIMENTS

Mobile robot allocation system 10 of the present disclosure includes obtainer 11, allocator 12, and outputter 13. Obtainer 11 obtains task status information regarding a task status of each of a plurality of areas, the plurality of areas each including a plurality of machines 1. Allocator 12 allocates, based on the task status information obtained by obtainer 11, a plurality of mobile robots 2 to the plurality of areas, the plurality of mobile robots 2 each moving and performing a task in an area among the plurality of areas. Outputter 13 outputs allocation information 31e indicating allocation of the plurality of mobile robots 2 performed by allocator 12.

According to this, the plurality of mobile robots 2 are allocated to the plurality of areas based on the task status in each of the plurality of areas, and allocation information 31e is outputted. Thus, the allocation of the plurality of mobile robots 2 to the plurality of areas can be easily optimized by reference to allocation information 31e.

Allocation information 31e may include information indicating a role of each of the plurality of mobile robots 2.

According to this, the roles of mobile robots 2 are also taken into consideration when allocating the plurality of mobile robots 2 to the plurality of areas. Thus, the allocation of the plurality of mobile robots 2 to the plurality of areas can be further optimized easily.

Each of the plurality of machines 1 may be a machine for producing a product. The task may include transporting, to machine 1 among the plurality of machines 1, a material required to produce the product or a cart carrying equipment required to produce the product.

According to this, mobile robot(s) 2 for material transportation or mobile robot(s) 2 for cart transportation can be easily allocated appropriately to each of the plurality of areas based on a production status in the area.

The task status information may include a total number of times the material or the cart is to be transported in each of the plurality of areas. Allocator 12 may allocate the plurality of mobile robots 2 to the plurality of areas to cause a total number of mobile robots 2 in each of the plurality of areas to be proportional to the total number of times the material or the cart is to be transported in the area.

According to this, mobile robot(s) 2 for material transportation or mobile robot(s) 2 for cart transportation can be easily allocated appropriately to each of the plurality of areas based on the total number of times the material or the cart is to be transported in the area.

Obtainer 11 may obtain production information regarding production of the product in each of the plurality of areas, and may calculate the total number of times the material or the cart is to be transported based on the production information.

According to this, mobile robot(s) 2 for material transportation or mobile robot(s) 2 for cart transportation can be easily allocated more appropriately to each of the plurality of areas by calculating the total number of times the material or the cart is to be transported based on the production information.

Mobile robot allocation system 10 of the present disclosure may further include task instructor 32 that gives a task instruction to each of the plurality of mobile robots 2. The task instruction may include an instruction to move to an area allocated by allocator 12.

According to this, each of the plurality of mobile robots 2 can be moved to an area among the plurality of areas without human intervention, thus improving the level of convenience.

A mobile robot allocation method of the present disclosure includes: obtaining task status information regarding a task status of each of a plurality of areas, the plurality of areas each including a plurality of machines 1; allocating, based on the task status information obtained, a plurality of mobile robots 2 to the plurality of areas, the plurality of mobile robots 2 each moving and performing a task in an area among the plurality of areas; and outputting allocation information 31e indicating allocation of the plurality of mobile robots 2.

According to this, the plurality of mobile robots 2 are allocated to the plurality of areas based on the task status in each of the plurality of areas, and allocation information 31e is outputted. Thus, the allocation of the plurality of mobile robots 2 to the plurality of areas can be easily optimized by reference to allocation information 31e.

Each of the exemplary embodiments described below shows a general or specific example. The numerical values, shapes, materials, elements, the arrangement and connection of the elements, steps, the processing order of the steps, etc. shown in the following exemplary embodiments are mere examples, and therefore do not limit the scope of the present disclosure.

### Embodiment

### 1. Overall Configuration

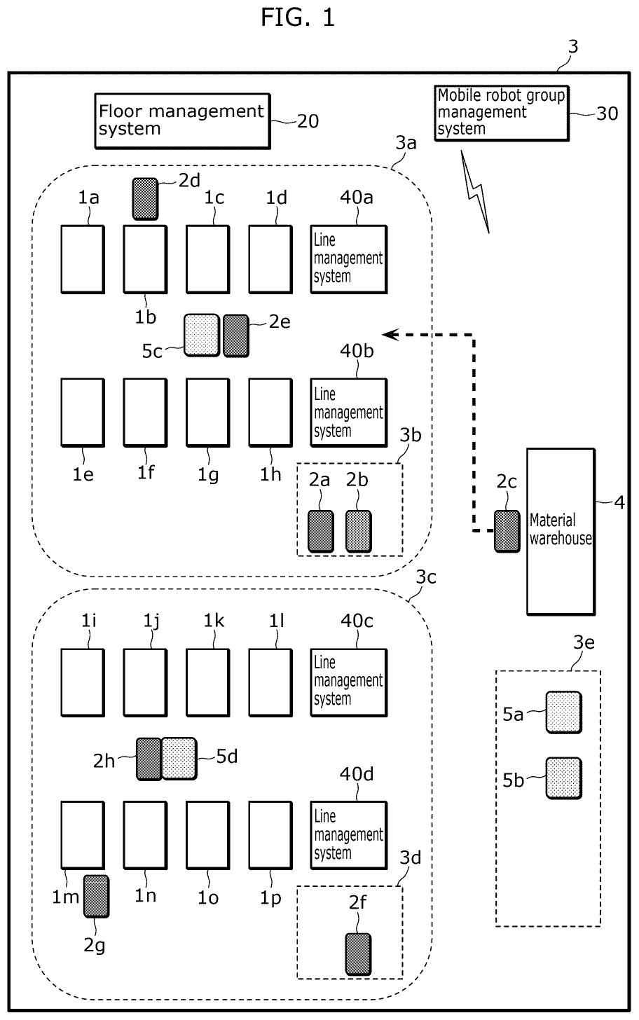

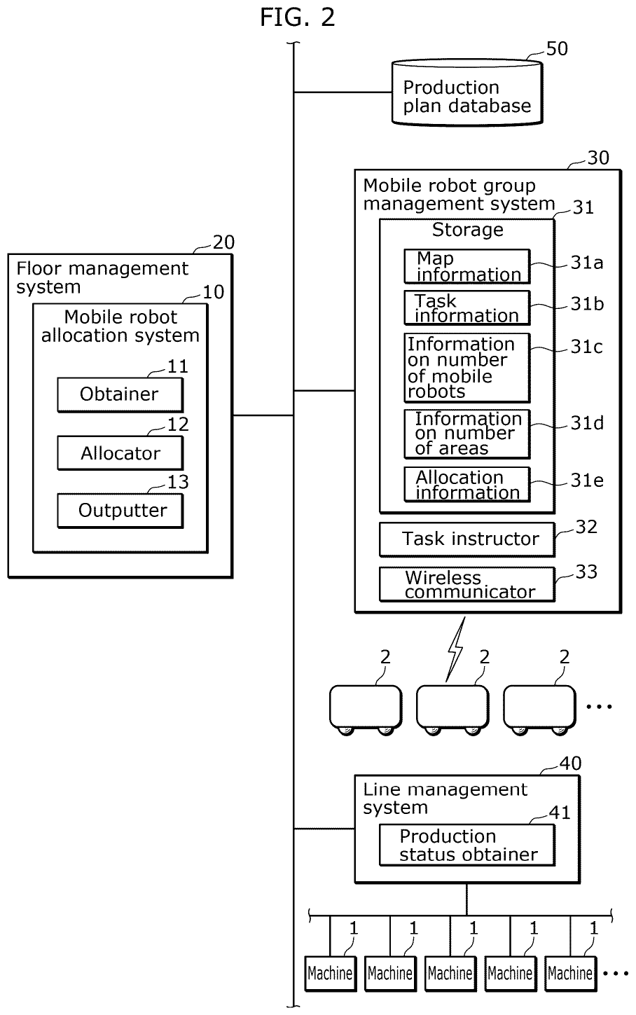

First, an overall configuration of mobile robot allocation system 10 according to an embodiment will be described with reference to FIGS. 1 and 2. FIG. 1 is a schematic diagram illustrating an application example of mobile robot allocation system 10 according to the embodiment. FIG. 2 is a configuration diagram illustrating an example of an overall configuration including mobile robot allocation system 10 according to the embodiment.

Mobile robot allocation system 10 is a system that allocates, to a plurality of areas, a plurality of mobile robots, each of which moves and performs a task in an area among the plurality of areas. Mobile robot allocation system 10 is applied, for example, to floor 3 on which a plurality of machines, a plurality of mobile robots, material warehouse 4, etc. are provided.

Material warehouse 4 is a warehouse in which materials, such as components to be used in each of the plurality of machines, are stored. The materials may include not only components each constituting a part of a product but also tools to be used in producing the product, for example. If a machine is a component mounting apparatus, for example, components include a substrate or mounting components to be mounted on the substrate, for example. If a machine is a component mounting apparatus, for example, tools include a metal mask or a suction nozzle, for example.

A plurality of machines are provided in each of first production area 3a and second production area 3c on floor 3. In the embodiment, each of the plurality of machines is a machine for producing a product. In other words, in the embodiment, first production area 3a and second production area 3c correspond to “the plurality of areas”. In the example shown in FIG. 1, machines 1a to 1h are provided in first production area 3a and machines 1i to 1p are provided in second production area 3c as the plurality of machines. Hereinafter, when machines 1a to 1p are not distinguished, these machines are each referred to simply as “machine 1”. Machines 1a to 1d constitute a first line of first production area 3a, and machines 1e to 1h constitute a second line of first production area 3a. Also, machines 1i to 1l constitute a third line of second production area 3c, and machines 1m to 1p constitute a fourth line of second production area 3c. Machine 1 is, for example, a component mounting apparatus, a printing apparatus, or an inspection apparatus.

In addition, a collection area where materials transported from material warehouse 4 are collected is provided in each of first production area 3a and second production area 3c. Note that FIG. 1 omits the illustration of these collection areas.

The plurality of mobile robots are allocated to the plurality of areas (in this case, first production area 3a and second production area 3c). In the example shown in FIG. 1, as the plurality of mobile robots, mobile robots 2a to 2e are allocated to first production area 3a and mobile robots 2f to 2h are allocated to second production area 3c. Hereinafter, when mobile robots 2a to 2h are not distinguished, these mobile robots are each referred to simply as “mobile robot 2”.

A task performed by mobile robot 2 may be, for example, a task of transporting a material to target machine 1 and supplying the material to that machine 1, or a task of moving to target machine 1 and collecting, for example, waste from that machine 1. A task performed by mobile robot 2 may also be a task of transporting a cart from cart standby area 3e, which is provided on floor 3, to target machine 1 and exchanging the cart, or a task of transporting a material from material warehouse 4 to one of the collection areas in the plurality of areas (in this case, first production area 3a and second production area 3c), for example. In the example shown in FIG. 1, carts 5a and 5b are on standby in cart standby area 3e.

The cart as used herein refers to an apparatus that includes wheels capable of traveling on a floor surface of floor 3 and that can supply a material to machine 1 by being attached to machine 1. If machine 1 is a component mounting apparatus, for example, the cart is an apparatus equipped with one or more component supply devices (e.g., feeders). Cart exchange is performed during a changeover (off-line setup) such as when switching to production of a different type of product than the product currently being produced, for example.

In the embodiment, each of the plurality of mobile robots 2 is assigned a specific role. Specifically, the plurality of mobile robots 2 include mobile robot 2 for material transportation, which has a role of transporting a material from the collection area to target machine 1 and supplying the material to that machine 1, and mobile robot 2 for cart transportation, which has a role of transporting a cart from cart standby area 3e to target machine 1 and exchanging the cart. Mobile robot 2 for material transportation has an ability to transport relatively lightweight objects, while mobile robot 2 for cart transportation has an ability to transport relatively heavy objects. The plurality of mobile robots 2 also include mobile robot 2 for the material warehouse, which has a role of transporting a material from material warehouse 4 to one of the collection areas of the plurality of areas (in this case, first production area 3a and second production area 3c).

In other words, in the embodiment, a task performed by mobile robot 2 includes transporting a material required to produce a product or a cart carrying equipment required to produce the product to machine 1 among the plurality of machines 1. The task of transporting the material from material warehouse 4 to one of the collection areas of the plurality of areas can be said, in an indirect sense, to be a task of transporting the material to machine 1 among the plurality of machines 1.

In first production area 3a, each of mobile robots 2a to 2e stands by in first standby area 3b when not working, and departs from first standby area 3b to move to a target machine among machines 1a to 1h or material warehouse 4 when working. In second production area 3c, each of mobile robots 2f to 2h stands by in second standby area 3d when not working, and departs from second standby area 3d to move to a target machine among machines 1i to 1p or material warehouse 4 when working.

In the example shown in FIG. 1, mobile robots 2a and 2b are on standby in first standby area 3b of first production area 3a, and mobile robot 2c is transporting a material from material warehouse 4 to the collection area in first production area 3a. A dashed arrow shown in FIG. 1 represents an example of a route traveled by mobile robot 2c to transport the material to the collection area in first production area 3a. Mobile robot 2d has transported a material from the collection area to machine 1b in the first line of first production area 3a and is supplying the material to machine 1b, and mobile robot 2e is transporting cart 5c in first production area 3a. Mobile robot 2f is on standby in second standby area 3d of second production area 3c, and mobile robot 2g has transported a material from the collection area to machine 1m in the fourth line of second production area 3c and supplying the material to machine 1m. Mobile robot 2h is transporting cart 5d in second production area 3c.

Floor management t system 20, mobile robot group management system 30, and line management systems 40a to 40d are further provided on floor 3. Hereinafter, when line management systems 40a to 40d are not distinguished, these line management systems are each referred to simply as “line management system 40”.

Floor management system 20 is a system that manages entire floor 3. Floor management system 20 manages entire floor 3 based on information obtained from mobile robot group management system 30 and each of line management systems 40, as well as a production plan obtained from production plan database 50. The production plan may include information regarding a type of product to be produced, the number of products to be produced, and materials (components) of the product. The production plan may also include information indicating scheduled time to start production and scheduled time to end the production, for example. The production plan is created in units of hours, days, or months, for example.

As a specific example, floor management system 20 generates task information 31b for each of mobile robots 2 based on the production plan obtained from production plan database 50. Task information 31b is information regarding details of tasks to be performed by mobile robots 2, which are required to achieve the production plan. Specific details of task information 31b will be described later. Floor management system 20 transmits generated task information 31b to mobile robot group management system 30.

Floor management system 20 includes mobile robot allocation system 10. Mobile robot allocation system 10 allocates the plurality of mobile robots 2 to the plurality of areas (in this case, first production area 3a and second production area 3c) and transmits allocation information 31e to mobile robot group management system 30 (the details will be described later). A manager of floor 3, for example, can then allocate the plurality of mobile robots 2 to the plurality of areas in an optimized manner by referring to allocation information 31e.

Mobile robot group management system 30 is a system that manages and controls the plurality of mobile robots 2. Mobile robot group management system 30 includes storage 31, task instructor 32, and wireless communicator 33.

Storage 31 stores map information 31a, task information 31b, information 31c on the number of mobile robots, information 31d on the number of areas, and allocation information 31e.

Map information 31a includes information on locations of, for example, first production area 3a and second production area 3c, the plurality of machines 1, material warehouse 4, first standby area 3b and second standby area 3d, and cart standby area 3e on floor 3. Map information 31a is prestored in storage 31, for example.

Task information 31b includes information indicating, for each of the plurality of mobile robots 2, when mobile robot 2 will move and what kind of task mobile robot 2 will perform. For example, task information 31b may include, for each of the plurality of mobile robots 2, time at which mobile robot 2 should depart from first standby area 3b or second standby area 3d, location information of a destination place, and time at which mobile robot 2 should arrive at the destination place, for example. Task information 31b may also include information indicating, for each of the plurality of mobile robots 2, a route to a destination place and information indicating details of a task to be performed at the destination place, for example. The destination place is, for example, target machine 1 in the case of mobile robot 2 for material transportation and mobile robot 2 for cart transportation. In the case of mobile robot 2 for the material warehouse, the destination place is a target area (in this case, first production area 3a or second production area 3c).

Information 31c on the number of mobile robots includes information indicating the number of a plurality of mobile robots 2 that are located on floor 3 and can be operated. In the example shown in FIG. 1, information 31c on the number of mobile robots is information indicating that a total of eight operable mobile robots 2 are located on floor 3.

Information 31d on the number of areas includes information indicating the number of floors, located on floor 3, where mobile robots 2 perform tasks. In the example shown in FIG. 1, information 31d on the number of areas is information indicating the number of, i.e., a total of two, production areas (first production area 3a and second production area 3c) located on floor 3.

Allocation information 31e includes information indicating allocation of the plurality of mobile robots 2 to the plurality of areas. In the example shown in FIG. 1, allocation information 31e includes information indicating that five mobile robots 2 are allocated to first production area 3a and three mobile robots 2 are allocated to second production area 3c. Allocation information 31e may also include information indicating what kind of roles mobile robots 2 allocated to each of the plurality of areas have. In other words, allocation information 31e may include information indicating the role of each of the plurality of mobile robots 2.

In the example shown in FIG. 1, allocation information 31e includes information indicating that two mobile robots 2 for material transportation, two mobile robots 2 for cart transportation, and one mobile robot 2 for the material warehouse are allocated to first production area 3a. Allocation information 31e also includes information indicating that one mobile robot 2 for material transportation, one mobile robot 2 for cart transportation, and one mobile robot 2 for the material warehouse are allocated to second production area 3c.

Task instructor 32 gives task instructions to the plurality of mobile robots 2 by transmitting the task instructions to the plurality of mobile robots 2 via wireless communicator 33. Each of the plurality of mobile robots 2 moves automatically according to the received task instruction. Task instructor 32 transmits the task instructions to the plurality of mobile robots 2 using task information 31b, etc.

Wireless communicator 33 is a communication interface for wireless communication between mobile robot group management system 30 and the plurality of mobile robots 2. Task instructor 32 communicates wirelessly with each of the plurality of mobile robots 2 via wireless communicator 33 to control such mobile robot 2.

Line management system 40 is a system that manages and controls one or more machines 1 constituting corresponding one of the lines. In the example shown in FIG. 1, line management system 40a manages and controls machines 1a to 1d that constitute the first line, and line management system 40b manages and controls machines 1e to 1h that constitute the second line. Line management system 40c manages and controls machines 1i to 1l that constitute the third line, and line management system 40d manages and controls machines 1m to 1p that constitute the fourth line.

Line management system 40 includes production status obtainer 41. Production status obtainer 41 obtains production status information regarding a production status at each of one or more machines 1 that constitute corresponding one of the lines. The production status information may include, for example, information regarding whether machine 1 is adequately supplied with materials required for the production, and include, if machine 1 has a shortage of the materials, information regarding a type of the scarce material and a quantity of the scarce material. Line management system 40 transmits the production status information obtained by production status obtainer 41 to floor management system 20.

### 2. Mobile Robot Allocation System

Next, mobile robot allocation system 10 will be described in detail. Mobile robot allocation system 10 is a system including a processor, a communication interface, and a memory, for example. Examples of the memory include a read only memory (ROM) and a random access memory (RAM). Such a memory can store programs to be executed by the processor. The configuration of mobile robot allocation system 10 is implemented by the processor executing the programs stored in the memory.

As shown in FIG. 2, mobile robot allocation system 10 is provided in floor management system 20. Mobile robot allocation system 10 includes obtainer 11, allocator 12, and outputter 13.

In the embodiment, obtainer 11, allocator 12, and outputter 13 are provided in floor management system 20, but the present disclosure is not limited thereto. In other words, these functional elements of mobile robot allocation system 10 may be provided in a single apparatus (or system) different from floor management system 20 or may be distributed among a plurality of apparatuses (or systems).

Obtainer 11 obtains task status information regarding a task status of each of the plurality of areas (in this case, first production area 3a and second production area 3c), the plurality of areas each including the plurality of machines 1. In the embodiment, the task status information includes the number of times materials or carts are to be transported in each of the plurality of areas. Specifically, the task status information includes the number of times materials are to be transported and the number of times carts are to be transported that are required to achieve the production plan in first production area 3a. The task status information also includes the number of times materials are to be transported and the number of times carts are to be transported that are required to achieve the production plan in second production area 3c.

In the embodiment, obtainer 11 obtains production information regarding the production of a product in each of the plurality of areas and calculates the number of times materials or carts are to be transported based on the production information. Specifically, obtainer 11 obtains the production plan from production plan database 50 and also obtains production data, for example, from an input provided by the manager or from another external system. The production data, which is also referred to as production program data, includes information regarding types, quantities, and an arrangement of materials (components) required to produce a single product, as well as cycle time. Cycle time is the time required to produce a single product. Obtainer 11 also obtains information 31c on the number of mobile robots and information 31d on the number of areas from mobile robot group management system 30.

Subsequently, obtainer 11 calculates the number of times materials are to be transported in each of the plurality of areas based on the obtained production plan and production data. For example, for each of the plurality of areas, obtainer 11 identifies types of materials required to achieve the production plan and calculates the total quantity of each of the materials based on the number of products to be produced, which is obtained by referring to the production plan, as well as the types and the quantities of the materials (components) required for a single production, which are obtained by referring to the production data. Based on these types and total quantities of the materials as well as a quantity of each of the materials that can be transported by one mobile robot 2, obtainer 11 calculates the number of times the materials are to be transported in each of the plurality of areas. Similarly, obtainer 11 calculates the number of times materials are to be transported from material warehouse 4 to the collection area in each of the plurality of areas based on the obtained production plan and production data. Obtainer 11 also calculates the number of times carts are to be transported in each of the plurality of areas based on the obtained production data. For example, obtainer 11 calculates, for each of the plurality of areas, the number of times carts are to be transported based on the number of changeovers (off-line setups), which is obtained by referring to the production data.

Allocator 12 allocates the plurality of mobile robots 2 to the plurality of areas (in this case, first production area 3a and second production area 3c) based on the task status information obtained by obtainer 11. In the embodiment, allocator 12 allocates the plurality of mobile robots 2 to the plurality of areas such that the number of mobile robots 2 is proportional to the number of times materials or carts are to be transported in each of the plurality of areas. In the embodiment, allocator 12 allocates the plurality of mobile robots 2 to the plurality of areas while taking into consideration also the role of each of the plurality of mobile robots 2.

A specific example of allocation performed by allocator 12 will be described below. The following description is provided assuming that the number of mobile robots 2 located on floor 3 is 10 and the number of the plurality of areas is two. The description is provided also assuming that task status information obtained by obtainer 11 includes information indicating that the total number of times materials are to be transported is 100, of which 70 transports are performed in first production area 3a and 30 transports are performed in second production area 3c. The description is provided also assuming that the task status information includes information indicating that the total number of times carts are to be transported is 10, of which eight transports are performed in first production area 3a and two transports are performed in second production area 3c. The description is provided further assuming that the task status information includes information indicating that the total number of times materials are to be transported from material warehouse 4 to the collection areas of the plurality of areas is 50, of which the number of transports to first production area 3a is 25 and the number of transports to second production area 3c is 25.

First, allocator 12 calculates the number of mobile robots 2 to be allocated to each of the plurality of areas. Specifically, the number of mobile robots 2 to be allocated to first production area 3a, “a1”, is calculated by Formula 1 “a1≈b×(c1÷d)”. In Formula 1, “b” represents the number of mobile robots 2 located on floor 3, “c1” represents the total number of transports in first production area 3a, and “d” represents the total number of transports in the all areas. As a result of the application of the above specific numerical values to Formula 1, the number of mobile robots 2 to be allocated to first production area 3a, “a1”, is determined to be six by calculating “10×{(70+8+25)÷(100+10+50)}”.

Similarly, the number of mobile robots 2 to be allocated to second production area 3c, “a2”, is calculated by Formula 2 “a2≈b×(c2÷d)”. In Formula 2, “c2” represents the total number of transports in second production area 3c, and “b” and “d” are the same as those in Formula 1. As a result of the application of the above specific numerical values to Formula 2, the number of mobile robots 2 to be allocated to second production area 3c, “a2”, is determined to be four by calculating “10×{(30+2+25)÷(100+10+50)}”.

Next, allocator 12 assigns roles to the plurality of mobile robots 2 in each of the plurality of areas. In other words, allocator 12 determines, for each of the plurality of areas, the number of mobile robots 2 each assigned as a mobile robot for material transportation, the number of mobile robots 2 each assigned as a mobile robot for cart transportation, and the number of mobile robots 2 each assigned as a mobile robot for the material warehouse.

Specifically, the number of mobile robots 2 for material transportation to be allocated to first production area 3a, “a11”, is calculated by Formula 3 “a11≈a1×(e1÷c1)”. In Formula 3, “e1” represents the number of times materials are to be transported in first production area 3a, and “a1” and “c1” are the same as those in Formula 1. As a result of the application of the above specific numerical values to Formula 3, the number of mobile robots 2 for material transportation to be allocated to first production area 3a, “a11”, is determined to be four by calculating “6×{70÷(70+8+25)}”.

The number of mobile robots 2 for cart transportation to be allocated to first production area 3a, “a12”, is calculated by Formula 4 “a12≈a1×(f1÷c1)”. In Formula 4, “f1” represents the number of times carts are to be transported in first production area 3a, and “a1” and “c1” are the same as those in Formula 1. As a result of the application of the above specific numerical values to Formula 4, the number of mobile robots 2 for cart transportation to be allocated to first production area 3a, “a12”, is determined to be one by calculating “6×{8÷(70+8+25)}”.

The number of mobile robots 2 for the material warehouse to be allocated to first production area 3a, “a13”, is calculated by Formula 5 “a13≈a1×(g1÷c1)”. In Formula 5, “g1” represents the number of times materials are to be transported to the collection area of first production area 3a, and “a1” and “c1” are the same as those in Formula 1. As a result of the application of the above specific numerical values to Formula 5, the number of mobile robots 2 for the material warehouse to be allocated to first production area 3a, “a13”, is determined to be one by calculating “6×{25÷(70+8+25)}”.

Similarly, the number of mobile robots 2 for material transportation to be allocated to second production area 3c, “a21”, is calculated by Formula 6 “a21≈a2×(e2÷c2)”. In Formula 6, “e2” represents the number of times materials are to be transported in second production area 3c, and “a2” and “c2” are the same as those in Formula 2. As a result of the application of the above specific numerical values to Formula 6, the number of mobile robots 2 for material transportation to be allocated to second production area 3c, “a21”, is determined to be two by calculating “4×{30÷(30+2+25)}”.

The number of mobile robots 2 for cart transportation to be allocated to second production area 3c, “a22”, is calculated by Formula 7 “a22≈a2×(f2÷c2)”. In Formula 7, “f2” represents the number of times carts are to be transported in second production area 3c, and “a2” and “c2” are the same as those in Formula 2. As a result of the application of the above specific numerical values to Formula 7, the number of mobile robots 2 for cart transportation to be allocated to second production area 3c, “a22”, is determined to be one by calculating “4×{2÷(30+2+25)}”.

The number of mobile robots 2 for the material warehouse to be allocated to second production area 3c, “a23”, is calculated by Formula 8 “a23≈a2×(g2÷c2)”. In Formula 8, “g2” represents the number of times materials are to be transported to the collection area of second production area 3c, and “a2” and “c2” are the same as those in Formula 2. As a result of the application of the above specific numerical values to Formula 8, the number of mobile robots 2 for the material warehouse to be allocated to second production area 3c, “a23”, is determined to be one by calculating “4×{25÷(30+2+25)}”.

Therefore, in the above specific example, allocation information 31e generated by allocator 12 includes information indicating that a total of six mobile robots 2, specifically, four mobile robots for material transportation, one mobile robot 2 for cart transportation, and one mobile robot 2 for the material warehouse, are allocated to first production area 3a. Allocation information 31e also includes information indicating that a total of four mobile robots 2, specifically, two mobile robots for material transportation, one mobile robot 2 for cart transportation, and one mobile robot 2 for the material warehouse, are allocated to second production area 3c.

Outputter 13 outputs allocation information 31e indicating the allocation of the plurality of mobile robots 2 performed by allocator 12. In the embodiment, outputter 13 transmits (outputs) allocation information 31e generated by allocator 12 to mobile robot group management system 30. Mobile robot group management system 30 stores received allocation information 31e in storage 31.

In the embodiment, mobile robot group management system 30 presents allocation information 31e to the manager by transmitting allocation information 31e to an information terminal used by the manager, for example. The information terminal may be, for example, a smartphone, a tablet terminal, or a desktop or laptop personal computer. Allocation information 31e is visually displayed on a display of the information terminal, for example. The manager allocates the plurality of mobile robots 2 to the plurality of areas (in this case, first production area 3a and second production area 3c) by moving the plurality of mobile robots 2 according to allocation information 31e.

In other words, it can be said that outputter 13 indirectly presents (outputs) allocation information 31e to the manager via mobile robot group management system 30. Outputter 13 may directly present (output) allocation information 31e to the manager by transmitting allocation information 31e to the information terminal used by the manager without going through mobile robot group management system 30.

### 3. Operations

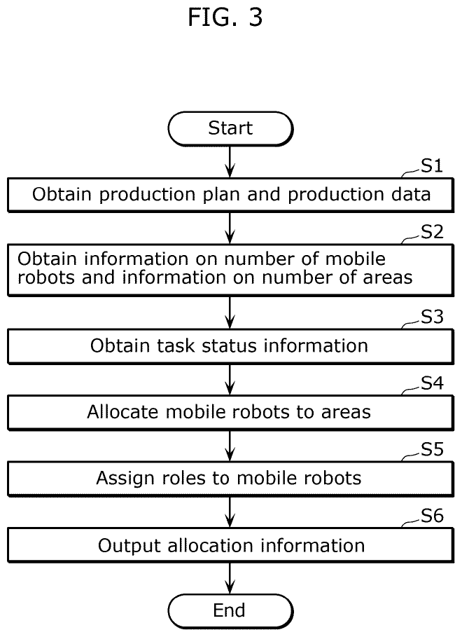

Operations of mobile robot allocation system 10 according to the embodiment will be described below with reference to FIG. 3. FIG. 3 is a flowchart showing exemplary operations of mobile robot allocation system 10 according to the embodiment. The following describes allocating a plurality of mobile robots 2 to a plurality of areas prior to the execution of a production plan. As a matter of course, the operations described below are not limited to this. For example, during the execution of the production plan, the allocation of the plurality of mobile robots 2 to the plurality of areas may be updated each time the content of the production plan is changed.

First, obtainer 11 obtains a production plan from production plan database 50 and also obtains production data, for example, from an input provided by a manager or from another external system (step S1). Obtainer 11 also obtains information 31c on the number of mobile robots and information 31d on the number of areas from mobile robot group management system 30 (step S2). The executing order of steps S1 and S2 may be reversed. Obtainer 11 then obtains task status information by calculating the number of times materials or carts are to be transported in each of the plurality of areas based on the obtained production plan and production data (i.e., production information) (step S3).

Next, allocator 12 allocates the plurality of mobile robots 2 to the plurality of areas based on the task status information, information 31c on the number of mobile robots, and information 31d on the number of areas, which have been obtained by obtainer 11 (step S4). Here, as already mentioned, allocator 12 allocates the plurality of mobile robots 2 to the plurality of areas such that the number of mobile robots 2 in each of the plurality of areas is proportional to the number of times materials or carts are to be transported in the area. Allocator 12 further assigns roles to the plurality of mobile robots 2 in each of the plurality of areas (step S5). Here, as already mentioned, allocator 12 determines, for each of the plurality of areas, the number of mobile robots 2 each assigned as a mobile robot for material transportation, the number of mobile robots 2 each assigned as a mobile robot for cart transportation, and the number of mobile robots 2 each assigned as a mobile robot for the material warehouse, using Formulas 1 through 6 described above.

Outputter 13 then outputs allocation information 31e generated by allocator 12 (step S6). Here, as already mentioned, outputter 13 transmits (outputs) allocation information 31e generated by allocator 12 to mobile robot group management system 30. Outputter 13 thereby indirectly presents (outputs) allocation information 31e to the manager via mobile robot group management system 30.

As described above, mobile robot allocation system 10 of the present disclosure allocates the plurality of mobile robots 2 to the plurality of areas based on the task status in each of the plurality of areas and outputs allocation information 31e. Therefore, according to mobile robot allocation system 10 of the present disclosure, the allocation of the plurality of mobile robots 2 to the plurality of areas can be easily optimized by referring to allocation information 31e.

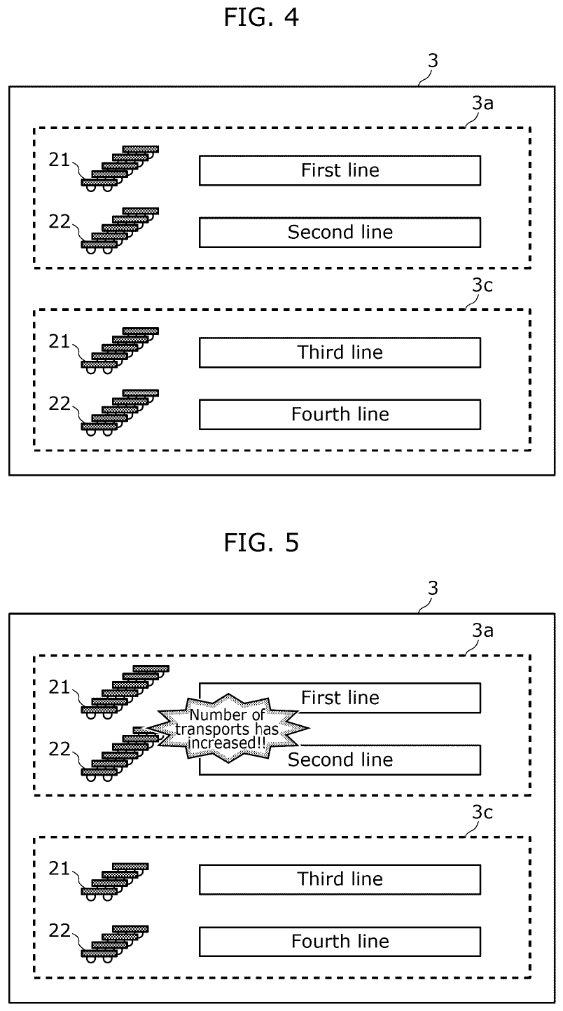

Such an advantage will be described below with a specific example. FIGS. 4 and 5 are each a schematic diagram illustrating an example of use of mobile robot allocation system 10 according to the embodiment. In the example shown in FIGS. 4 and 5, five mobile robots 21 for material transportation and five mobile robots 22 for cart transportation are allocated to first production area 3a. Also, five mobile robots 21 for material transportation and five mobile robots 22 for cart transportation are allocated to second production area 3c. For the ease of description, the illustration and description of mobile robot 2 for the material warehouse are omitted.

It is now assumed that the number of transports required in first production area 3a has increased due to a change in the content of the production plan, for example. Such a change in the content of the production plan may occur, for example, when one type of product was being produced in all lines before the change, but the number of types of products to be produced has increased to produce many types of products in first production area 3a. In this case, if the allocation of the plurality of mobile robots 2 between first production area 3a and second production area 3c is unchanged, material transportation and cart transportation in first production area 3a will tend to be insufficient, which may cause delay in the production of the products. In other words, in such a case, the tasks of mobile robots 2 may be delayed or mobile robots 2 may have low utilization rates in some areas.

To solve the above-described problems, the manager needs to change the allocation of the plurality of mobile robots 2. However, it is difficult for the manager to grasp a change in the content of the production plan in real time and to determine the appropriate allocation of the plurality of mobile robots 2 according to the content of the production plan.

In view of the above, mobile robot allocation system 10 according to the embodiment updates the allocation of the plurality of mobile robots 2 between first production area 3a and second production area 3c in real time according to a change in the content of the production plan.

Specifically, as shown in FIG. 5, mobile robot allocation system 10 updates allocation information 31e such that six mobile robots 21 for material transportation and six mobile robots 22 for cart transportation are allocated to first production area 3a, and four mobile robots 21 for material transportation and four mobile robots 22 for cart transportation are allocated to second production area 3c. This allows the manager to appropriately allocate the plurality of mobile robots 2 to first production area 3a and second production area 3c by moving the plurality of mobile robots 2 according to updated allocation information 31e.

### Other Embodiments

Although mobile robot allocation system 10 of the present disclosure has been described above with reference to the embodiment, the present disclosure is not limited to the above embodiment. Forms obtained by making various modifications to the present embodiment that can be conceived by those skilled in the art, as well as forms obtained by combining structural components in different embodiments, without materially departing from the spirit of the present disclosure, may be included in the scope of the present disclosure.

In the above embodiment, the task instructions are given to mobile robots 2 from mobile robot group management system 30, but the present disclosure is not limited thereto. For example, a task instruction may be given to mobile robot 2 by an operator operating that mobile robot 2 after placing materials on that mobile robot 2.

In the above embodiment, each of the plurality of mobile robots 2 is assigned a fixed role, but the present disclosure is not limited thereto. For example, some or all of the plurality of mobile robots 2 may be configured to be able to change their roles. Specifically, some or all of the plurality of mobile robots 2 may each be configured to be switchable between the role of transporting a material and the role of transporting a cart. In this case, since the roles of some or all of the plurality of mobile robots 2 can be changed as needed based on the task status, the plurality of mobile robots 2 can be allocated more flexibly than in the case where the roles of the plurality of mobile robots 2 are fixed.

In the above embodiment, the manager moves each of the plurality of mobile robots 2 to an area among the plurality of areas according to allocation information 31e, i.e., each of the plurality of mobile robots is moved to an area among the plurality of areas by human intervention, but the present disclosure is not limited thereto. For example, task instructor 32 in mobile robot group management system 30 may automatically move each of the plurality of mobile robots 2 to its allocated area by remotely controlling that mobile robot 2 according to allocation information 31e. In other words, the task instruction given by task instructor 32 to each of the plurality of mobile robots 2 may include an instruction to move to the area allocated by allocator 12. In this case, task instructor 32 is included as a component of mobile robot allocation system 10.

In the above embodiment, obtainer 11 obtains task status information by obtaining production information regarding the production of a product in each of the plurality of areas and calculating the number of times materials or carts are to be transported based on the production information. However, the present disclosure is not limited to this. For example, obtainer 11 may obtain task status information by obtaining the number of transports from, for example, an external system without calculating the number of transports as described above.

In the above embodiment, allocator 12 allocates the plurality of mobile robots 2 to the plurality of areas based on the number of times materials or carts are to be transported in each of the plurality of areas. However, the present disclosure is not limited to this. For example, allocator 12 may allocate the plurality of mobile robots 2 to the plurality of areas based on a degree of progress of the production plan. Specifically, if a delay in the production plan has occurred in first production area 3a, allocator 12 may allocate, to first production area 3a, a larger number of mobile robots 2 than usual.

For example, the present disclosure can be implemented not only as mobile robot allocation system 10, but also as a mobile robot allocation method including steps (processes) performed by the components of mobile robot allocation system 10.

As shown in FIG. 3, the mobile robot allocation method is a method including: obtaining task status information regarding a task status of each of a plurality of areas, the plurality of areas each including a plurality of machines 1 (step S3); allocating, based on the task status information obtained, a plurality of mobile robots 2 to the plurality of areas, the plurality of mobile robots 2 each moving and performing a task in an area among the plurality of areas (steps S4 and S5); and outputting allocation information 31e indicating the allocation of the plurality of mobile robots 2 (step S6).

For example, the steps in the mobile robot control method may be executed by a computer (computer system). The present disclosure can then be implemented as a program for causing the computer to execute the steps included in the mobile robot control method. Furthermore, the present disclosure can be implemented as a non-transitory computer-readable recording medium, such as a CD-ROM, on which the program is recorded.

For example, if the present disclosure is implemented as a program (software), the program is executed using hardware resources such as a central processing unit (CPU), a memory, and input and output circuits of a computer to perform each of the steps. In other words, each step is executed, for example, by the CPU obtaining data from the memory or the input and output circuits, for example, to perform operations on the data, and outputting the calculation results to the memory or the input and output circuits, for example.

Each component included in mobile robot allocation system 10 according to the above embodiment may be implemented as a dedicated circuit or a general-purpose circuit.

Each component included in mobile robot allocation system 10 according to the above embodiment may be implemented as a large scale integration (LSI) chip, which is an integrated circuit (IC).

The integrated circuit is not limited to such an LSI chip, and may be implemented using a dedicated circuit or a general-purpose processor. A field programmable gate array (FPGA), which can be programmed, or a reconfigurable processor, which can reconfigure the connections and settings of circuit cells inside an LSI chip, may also be used.

Furthermore, as a matter of course, if a circuit integration technology that replaces LSI appears through advances in semiconductor technology or due to another derivative technology, the circuit integration of the components included in mobile robot allocation system 10 may be performed using that technology.

Forms obtained by making various modifications to the above embodiment that can be conceived by those skilled in the art, as well as forms obtained by combining structural components and functions in different embodiments, without materially departing from the spirit of the present disclosure, may also be included in the scope of the present disclosure.

### INDUSTRIAL APPLICABILITY

The present disclosure can be applied, for example, to a system for transporting materials such as components.

### REFERENCE SIGNS LIST

1, 1a to 1p Machine
2, 21, 22, 2a to 2h Mobile robot
3 Floor
3a First production area
3b First standby area

13c Second production area
3d Second standby area 3e Cart standby area
4 Material warehouse
5a to 5d Cart
10 Mobile robot allocation system
11 Obtainer
12 Allocator
13 Outputter
20 Floor management system
30 Mobile robot group management system
31 Storage
31a Map information
31b Task information
31c Information on the number of mobile robots
31d Information on the number of areas
31e Allocation information
32 Task instructor
33 Wireless communicator
40, 40a to 40d Line management system
41 Production status obtainer
50 Production plan database
S1 to S6 Step

What is claimed is:

1. A mobile robot allocation system comprising:
an obtainer that obtains task status information regarding a task status of each of a plurality of areas, the plurality of areas each including a plurality of machines;
an allocator that allocates, based on the task status information obtained by the obtainer, a plurality of mobile robots to the plurality of areas, the plurality of mobile robots each moving and performing a task in an area among the plurality of areas; and
an outputter that outputs allocation information indicating allocation of the plurality of mobile robots performed by the allocator.

2. The mobile robot allocation system according to claim 1,
wherein the allocation information includes information indicating a role of each of the plurality of mobile robots.

3. The mobile robot allocation system according to claim 1,
wherein each of the plurality of machines is a machine for producing a product, and
the task includes transporting, to a machine among the plurality of machines, a material required to produce the product or a cart carrying equipment required to produce the product.

4. The mobile robot allocation system according to claim 3,
wherein the task status information includes a total number of times the material or the cart is to be transported in each of the plurality of areas, and
the allocator allocates the plurality of mobile robots to the plurality of areas to cause a total number of mobile robots in each of the plurality of areas to be proportional to the total number of times the material or the cart is to be transported in the area.

5. The mobile robot allocation system according to claim 4,
wherein the obtainer obtains production information regarding production of the product in each of the plurality of areas, and calculates the total number of times the material or the cart is to be transported based on the production information.

6. The mobile robot allocation system according to claim 1, further comprising:
a task instructor that gives a task instruction to each of the plurality of mobile robots,
wherein the task instruction includes an instruction to move to an area allocated by the allocator.

7. A mobile robot allocation method comprising:
obtaining task status information regarding a task status of each of a plurality of areas, the plurality of areas each including a plurality of machines;
allocating, based on the task status information obtained, a plurality of mobile robots to the plurality of areas, the plurality of mobile robots each moving and performing a task in an area among the plurality of areas; and
outputting allocation information indicating allocation of the plurality of mobile robots.
